(19) United States
(12) Patent Application Publication
(10) Pub. No.: US 2026/0208650 A1
(43) Pub. Date: Jul. 23, 2026

(54) ARTICLE HOLDING DEVICE

(71) Applicant: NIFCO INC., Yokosuka-shi, Kanagawa (JP)

(72) Inventor: Toshiaki SOMA, Yokosuka-shi, Kanagawa (JP)

(21) Appl. No.: 19/139,371

(22) PCT Filed: Jan. 10, 2024
(86) PCT No.: PCT/JP2024/000299

§ 371 Date: Jun. 16, 2025

(30) Foreign Application Priority Data
Jan. 31, 2023 (JP) 2023-012509

(51) Int. Cl. B60N 3/10

(52) U.S. Cl. CPC B60N 3/108

(57) ABSTRACT

When an article enters a housing, an upper portion of an arm slidingly contacts the article by receiving a downward external force from the article, and rotates about a shaft so as to exit the housing. One of the holder and the arm includes the shaft. The other of the holder and the arm includes a bearing. The bearing includes a slot in which the shaft is inserted, and the slot is formed so as to allow rotation of the shaft about the slot and translation of the shaft with respect to the slot by an external force. The upper portion of the arm exits the housing when the shaft moves in conjunction with the translation of the shaft with respect to the slot.

### FIELD

The present disclosure relates to an article holding device that holds an article such as a bottle or a cup.

### BACKGROUND

Patent Literature 1 discloses a cup holder that is an example of the article holding device. The cup holder includes a holder and an arm that is urged into a housing of the holder by an urging unit. A shaft provided at the lower end of the arm is rotatably supported by a bearing of the holder. The arm enters the housing of the holder or exits the housing through an opening of the holder. The bearing of the holder projects outward from an outer peripheral surface of a side wall and is located below the opening of the holder.

When the cup is pushed in toward the bottom of the holder, a pressing force by the cup acts on a sloping surface of the arm. The pressing force acting on the sloping surface of the arm causes the arm to exit from the housing against an urging force of the urging unit so as to push out the sloping surface of the arm from the cup toward the outside of the holder. When the cup is pulled out of the holder, the urging of the urging unit inserts the arm into the housing.

### CITATION LIST

### Patent Literature

Patent Literature 1: Japanese Patent Application Laid-open Publication No. 2016-159641

### SUMMARY OF THE INVENTION

### Technical Problem

The article holding device may accommodate a bottle with a bottom cover attached thereto. The bottom cover made of silicon resin or acrylonitrile butadiene styrene (ABS) resin stabilizes the posture of the bottle on a placement surface. A large frictional force is generated between the bottom cover and the sloping surface of the arm. The frictional force between the bottle and the arm hinders movement of the bottle relative to the sloping surface of the arm, and also makes the sloping surface of the arm difficult to be pushed out of the opening of the holder. As a result, an excessive amount of the frictional force hinders the arm from exiting the housing.

### Solution to Problem

According to one aspect of the present disclosure, an article holding device is provided that includes a holder including a housing configured to receive an article from above the housing, and an arm including an arm upper portion, in which when the article enters the housing, the arm upper portion slidingly contacts the article by receiving a downward external force from the article, and rotates about a shaft so as to exit the housing; one of the holder and the arm is a first member including the shaft; the other of the holder and the arm is a second member including a bearing; the bearing includes a slot in which the shaft is inserted; the slot is formed so as to allow rotation of the shaft about the slot and translation of the shaft with respect to the slot by the external force; the translation of the shaft with respect to the slot is restrained by an urging force; and the arm upper portion exits the housing when the shaft moves in conjunction with the translation.

According to one aspect of the present disclosure, an article holding device is provided that includes a holder including a housing configured to receive an article from above the housing, and an arm including an arm upper portion extending toward a lower inside of the housing, in which when the article enters the housing, the arm upper portion slidingly contacts the article by receiving a downward external force from the article, and rotates about a shaft so as to exit the housing; one of the holder and the arm includes the shaft; the other of the holder and the arm includes a bearing; the bearing includes a slot in which the shaft is inserted; the slot extends downwardly outward of the housing, and the slot is formed so as to allow rotation of the shaft about the slot and translation of the shaft with respect to the slot by the external force; the translation of the shaft with respect to the slot is restrained by an urging force; and the arm upper portion exits the housing when the shaft moves in conjunction with the translation.

### BRIEF DESCRIPTION OF DRAWINGS

FIG. 1 is a perspective view illustrating a configuration of an article holding device.

FIG. 2 is a perspective view illustrating a configuration of an arm.

FIG. 3 is a rear view illustrating the configuration of the arm.

FIG. 4 is a sectional perspective view illustrating a mounting structure of the arm.

FIG. 5 is another sectional perspective view illustrating the mounting structure of the arm.

FIG. 6 is an operation diagram illustrating an operation of the article holding device.

FIG. 7 is an operation diagram illustrating another operation of the article holding device.

### DESCRIPTION OF EMBODIMENTS

### Article Holding Device 10

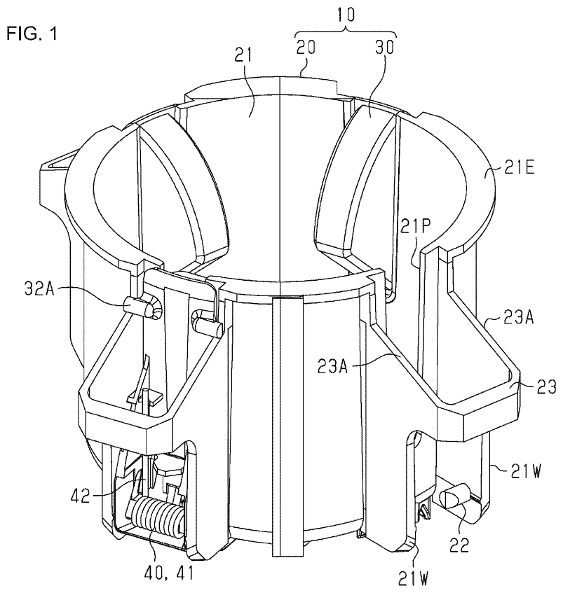

As illustrated in FIG. 1, an article holding device 10 includes a holder 20 and an arm 30. The holder 20 is an example of a guide member. The holder 20 includes a housing 21, a shaft 22, and a joint 23. For convenience of explanation of the structure of the holder 20, FIG. 1 does not illustrate two of the four arms 30. Examples of an article held by the article holding device 10 include a cup having a cylindrical shape or a cylindrical stand shape, or a bottle having a cylindrical shape, a cylindrical stand shape, or a cylindrical shape narrow in the middle.

### Holder 20

The housing 21 has a bottomed cylindrical shape extending in an upper-lower direction. The holder 20 receives the article from above the housing 21. The housing 21 has four openings 21P equally distributed in the peripheral direction of the housing 21. Each of the openings 21P extends downward from a top edge 21E of the housing 21. The opening 21P is sandwiched between two support walls 21W that protrude radially outward from the outer peripheral surface of the housing 21. The two support walls 21W have each a flat plate shape extending in the upper-lower direction and are arranged in a right-left direction. The shaft 22 and the joint 23 are formed integrally with the two support walls 21W.

The shaft 22 is provided one on each of the support walls 21W. The two shafts 22 are arranged at lower portions of the support walls 21W so as to face each other with the opening 21P interposed therebetween. The shaft 22 integral with one of the support walls 21W extends toward the other of the support walls 21W. The two shafts 22 are arranged so as to face each other.

One joint 23 is provided for the two support walls 21W. The joint 23 is located at the tops of the support walls 21. The joint 23 connects upper ends of the two support walls 21W. One joint 23 has one guide surface 23A at each of the support walls 21W. The guide surface 23A is an upper end surface of the support wall 21W.

The guide surface 23A projects downwardly outward from the outer peripheral surface of the housing 21. The two guide surfaces 23A are arranged in the right-left direction. The guide surface 23A is a flat surface having a slope that becomes higher in position as the guide surface becomes closer to the housing 21. The guide surface 23A extends outward beyond the shaft 22 in the radial direction of the housing 21. A guided boss 32A of the arm 30 abuts on the guide surface 23A from above.

### Arm 30

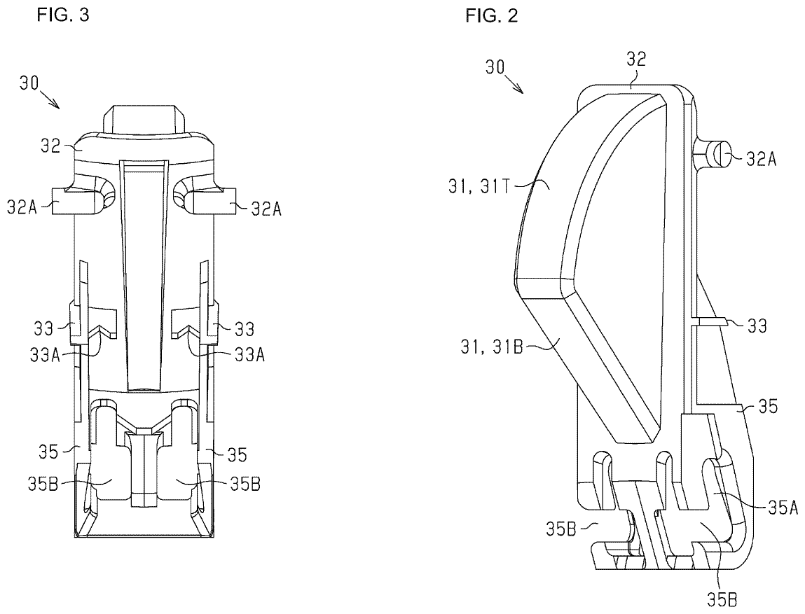

As illustrated in FIG. 2, the arm 30 includes a holding wall 31 and a locking wall 32.

The holding wall 31 has a beak shape that projects toward the interior of the housing 21. A projecting end of the holding wall 31 is an inner end of the arm 30. The holding wall 31 includes a first driven sloping surface 31T that is an example of an arm upper portion and a second driven sloping surface 31B.

The surface of the first driven sloping surface 31T is a sliding contact surface that extends from the upper end of the opening 21P toward the lower inside of the housing 21. The first driven sloping surface 31T becomes lower in position as the first driven sloping surface is located more inside the housing 21. The slope of the first driven sloping surface 31T toward the lower inside becomes larger as the slope of the first driven sloping surface is located more inside the housing 21. The first driven sloping surface 31T has an elliptic arc surface shape when viewed from the axial direction of the shaft 22. The first driven sloping surface 31T is located so as to abut on the article entering the housing 21 and to receive a downward external force from the article.

The second driven sloping surface 31B extends from the lower end of the first driven sloping surface 31T toward the lower end of the opening 21P. The second driven sloping surface 31B becomes higher in position as the second driven sloping surface is located more inside the housing 21. The upwardly inward slope of the second driven sloping surface 31B is approximately constant at portions thereof located in the housing 21.

The locking wall 32 has a flat plate shape that spreads so as to cover the opening 21P along the upper-lower direction.

The locking wall 32 is integral with the holding wall 31. The holding wall 31 projects inward from an inner surface of the locking wall 32. The locking wall 32 is disposed so as to protrude around the holding wall 31. The locking wall 32 contacts the periphery of the housing 21 from the outside of the housing 21 around the opening 21P in the outer circumference of the housing 21. With this configuration, an inward movement of the arm 30 into the housing 21 is restricted by the locking wall 32.

The upper end of the locking wall 32 includes a guided boss 32A. A side end surface of the locking wall 32 is a side surface of the arm 30. The guided boss 32A projects from the side surface of the arm 30 toward the top of the guide surface 23A. The guided boss 32A abuts on the guide surface 23A from above outside the housing 21. With this configuration, a downward movement of the arm 30 is restricted by the guide surface 23A.

As illustrated in FIG. 3, the arm 30 includes two hooking walls 33. The two hooking walls 33 are arranged in the right-left direction. Each of the hooking walls 33 has a flat plate shape that projects outward from an outer surface of the locking wall 32. The hooking wall 33 is located at an intermediate location in the upper-lower direction of the locking wall 32. The rear end of the hooking wall 33 is provided with an arm stop 33A. The arm stop 33A is recessed inward from the rear end of the arm 30.

The arm 30 includes two bearings 35. Each of the bearings 35 is located below the guided boss 32A and the hooking wall 33. The arm 30 includes one bearing 35 on each of the shafts 22.

### Bearing 35

Referring back to FIG. 2, the bearing 35 projects outward from a lower portion of the locking wall 32. The bearing 35 has a planar wall shape orthogonal to the locking wall 32. The two bearings 35 are arranged so as to face each other. The two bearings 35 are connected to each other at the lower end of the arm 30. The bearing 35 includes an actuating portion 35A and a mounting portion 35B. Each of the actuating portion 35A and the mounting portion 35B is a through-groove penetrating the bearing 35. The actuating portion 35A is an example of a slot.

Each of the actuating portion 35A and the mounting portion 35B connects a space outside the arm 30 to a space interposed between the two bearings 35. The groove width in each of the actuating portion 35A and the mounting portion 35B is large enough for the shaft 22 to pass therethrough. The groove width in each of the actuating portion 35A and the mounting portion 35B allows the shaft 22 to rotate relative to the bearing 35. The groove width of the actuating portion 35A allows translation of the shaft 22 with respect to the actuating portion 35A. The groove width of the actuating portion 35A may be large enough to guide the translation of the shaft 22 along a direction of extension of the actuating portion 35A. The groove width of the mounting portion 35B may be large enough to guide the translation of the shaft 22 with respect to the mounting portion 35B along a direction of extension of the mounting portion 35B.

The actuating portion 35A has a linear shape extending downwardly outward from the outer surface of the locking wall 32. The actuating portion 35A becomes lower in position as the actuating portion is located more outside the housing 21. The upwardly outward slope of the actuating portion 35A is approximately constant at portions thereof located outside the housing 21. The upper end of the actuating portion 35A is closed. The lower end of the actuating portion 35A continues to the mounting portion 35B. The mounting portion 35B is a path of the shaft 22 that continues to the lower end of actuating portion 35A.

The mounting portion 35B has a linear shape extending from the lower end of the actuating portion 35A toward the housing 21. The position in the upper-lower direction of the mounting portion 35B is almost constant at portions thereof located in the radial direction of the housing 21. The outer end of the mounting portion 35B continues to the actuating portion 35A. The inner end of mounting portion 35B is an opening. The opening of the mounting portion 35B allows the shaft 22 to pass from outside the arm 30 toward the mounting portion 35B. The actuating portion 35A and the mounting portion 35B have an inverted L-shape that bends at the outer end of the mounting portion 35B. The arm 30 includes a partition that extends upward from the bottom of the arm 30 between the two mounting portions 35B. The partition of the arm 30 has a width smaller than the distance between the two shafts 22 in the right-left direction.

The mounting portion 35B guides the shaft 22 to the actuating portion 35A through a relative movement of the shaft 22 along the mounting portion 35B. The mounting portion 35B continues to the actuating portion 35A such that the relative movement of the shaft 22 along the mounting portion 35B bends toward the actuating portion 35A. The actuating portion 35A receives the shaft 22 from the mounting portion 35B. The actuating portion 35A advances and retracts the housing 21 to and from the arm 30 through the relative movements of the shaft 22 along the actuating portion 35A.

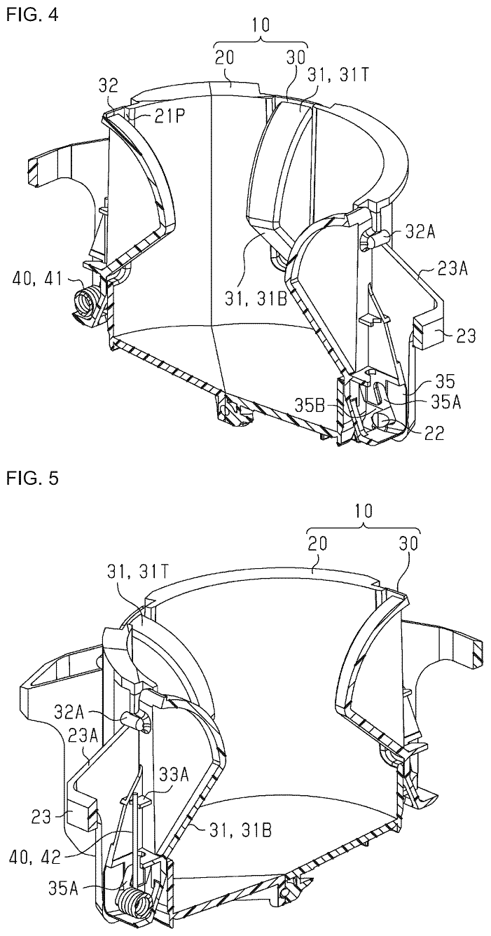

As illustrated in FIG. 4, the article holding device 10 includes a torsion coil spring 40. The torsion coil spring 40 is an example of an urging unit. The torsion coil spring 40 is attached to the two shafts 22.

As illustrated in FIG. 5, the torsion coil spring 40 includes one coil 41 and two spring arms 42. The shaft 22 is inserted in the coil 41. The length of the coil 41 in a direction of extension of the shaft 22 forms a gap between the two shafts 22. When the shaft 22 moves along the mounting portion 35B toward the opening of the mounting portion 35B, the coil 41 abuts on the partition of the arm 30, thereby restricting the shaft 22 from coming out of the mounting portion 35B. The two spring arms 42 extend in a tangential direction of the coil 41 from both ends in the axial direction of the coil 41. One of the spring arms 42 is hooked on the bottom surface of the holder 20 through the opening in the mounting portion 35B of the arm 30. The other of the spring arms 42 is hooked on one of the arm stops 33A.

The torsion coil spring 40 applies an urging force so as to widen an angle formed by the two spring arms 42 when viewed from the axial direction of the coil 41. The torsion coil spring 40 urges the arm stop 33A in the circumferential direction of the shaft 22 about the shaft 22. The arm stop 33A urged in the circumferential direction of the shaft 22 urges the arm 30 toward inside the housing 21. The torsion coil spring 40 thereby urges the arm 30 so as to enter the housing 21. The torsion coil spring 40 also urges the guided boss 32A toward the outer peripheral surface of the housing 21.

### Operation

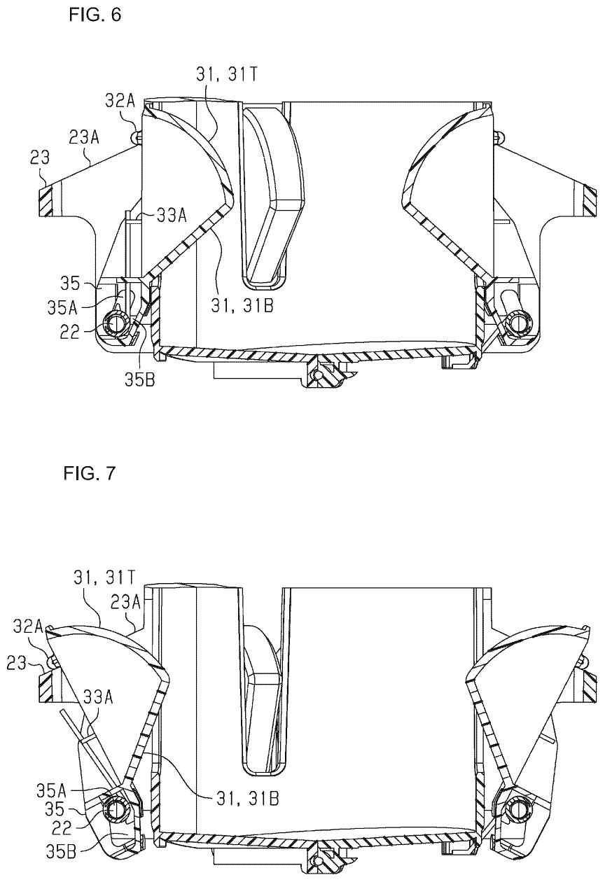

As illustrated in FIG. 6, the arm 30 urged toward inside the housing 21 first brings the guided boss 32A into contact with the upper end of the guide surface 23A and the outer peripheral surface of the housing 21 before the article is inserted into the housing 21. The arm 30 urged toward inside the housing 21 also brings the locking wall 32 into contact with the outer peripheral surface of the housing 21. The movement of the arm 30 with respect to the housing 21 is thereby restricted by the guide surface 23A and the outer peripheral surface of the housing 21. The movement of the shaft 22 with respect to the actuating portion 35A is also restricted by the guide surface 23A and the outer peripheral surface of the housing 21. The shaft 22 of the holder 20 is located at a lower portion in the actuating portion 35A of the arm 30.

Then, when the article is inserted into the housing 21, the first driven sloping surface 31T contacting with the article receives a downward external force from the article. The downward external force acting on the first driven sloping surface 31T from the article acts to push down a portion of the first driven sloping surface 31T that is in contact with the article.

At this time, if the coefficient of friction of the article is low as in the case where the article is slippery against the first driven sloping surface 31T, the first driven sloping surface 31T easily slides against the article.

Therefore, when the coefficient of friction of the article is low, the first driven sloping surface 31T slides against the article against the urging of the torsion coil spring 40 so as to lower the portion in contact with the article within the first driven sloping surface 31T. Since the first driven sloping surface 31T slides against the article, the external force to push the article downward does not act to push the first driven sloping surface 31T and the article downward together.

As a result, when the coefficient of friction of the article is low, the shaft 22 rotates in the actuating portion 35A while the position of the shaft 22 with respect to the actuating portion 35A is maintained, as an arrow in FIG. 6 indicates. The first driven sloping surface 31T then exits the housing 21 while the first driven sloping surface 31T slides against the article. The guided boss 32A of the arm 30 rotates about the shaft 22 and leaves the upper end of the guide surface 23A upwardly outward.

In contrast, if the coefficient of friction of the article is high as in the case where the article is difficult to slide against the first driven sloping surface 31T, the first driven sloping surface 31T is difficult to slide against the article. Therefore, a downward external force moves the first driven sloping surface 31T together with the article so as to lower the portion in contact with the article within the first driven sloping surface 31T against the urging of the torsion coil spring 40. In this case, the actuating portion 35A onto which the shaft 22 is inserted has a shape that allows not only the rotation of the shaft 22 with respect to the actuating portion 35A but also the translation of the shaft 22 with respect to the actuating portion 35A.

As a result, when the coefficient of friction of the article is high, the external force pushing the article downward moves the guided boss 32A downwardly outward along the guide surface 23A so as to push the first driven sloping surface 31T and the article downward together, as an arrow in FIG. 7 indicates. The first driven sloping surface 31T then exits the housing 21 while the downwardly outward movement of the first driven sloping surface 31T is paralleled with the sliding movement against the article.

### Effects

According to the embodiment described above, effects listed below are obtained.

(1) Whether the coefficient of friction of the article is low or high, the article holding device 10 can smoothly accommodate the articles.

(2) The holder 20 interlocks the rotation and the translation of the shaft 22 with respect to the actuating portion 35A with the movement of the guided boss 32A along the guide surface 23A. Therefore, the amounts of translation and rotation of the shaft 22 with respect to the actuating portion 35A are reproduced by the movement of the guided boss 32A along the guide surface 23A. As a result, the article holding device 10 obtains reproducibility of the posture of the arm 30 when exiting.

(3) Since the guide surface 23A extends downwardly outward of the housing 21, the movement of the guided boss 32A along the guide surface 23A, and as a result, the translation and the rotation of the shaft 22 with respect to the actuating portion 35A is smoothly performed by the downward external force.

(4) Since the guided boss 32A is a projection extending from the side surface of the arm 30, the guided boss 32A can be easily assembled to the guide surface 23A.

(5) The torsion coil spring 40 that urges the arm 30 inward restrains the translation of the shaft 22 with respect to the actuating portion 35A. Therefore, the number of components included in the article holding device 10 can also be made smaller than that in a configuration in which a member to urge the arm 30 inward and a member to restrain the translation of the shaft 22 are separately provided.

(6) The mounting portion 35B for introducing the shaft 22 to the actuating portion 35A extends in a direction different from the direction of extension of the actuating portion 35A.

This configuration also restrains the shaft 22 from coming off the actuating portion 35A.

(7) The mounting portion 35B has an opening to allow the shaft 22 to pass through at an end opposite an end continuing to the actuating portion 35A. This configuration also facilitates work to assemble the shaft 22 to the actuating portion 35A. This configuration also facilitates a worker to intuitively understand a work method for mounting the shaft 22 into the bearing 35.

The embodiment described above can also be implemented with the following modifications.

### Guide Member

The article holding device 10 may exclude the guide from the holder 20 and include a guided unit in the holder 20, and may exclude the guided unit from the arm 30 and include a guide in the arm 30. For example, the arm 30 may have the guide surface 23A extending downwardly outward, and the holder 20 may include the guided boss 32A projecting below the guide surface 23A. The article holding device 10 may interlock the movement of the shaft 22 with respect to the actuating portion 35A with the relative movement of the guided boss 32A of the holder 20 along the guide surface 23A of the arm 30. In this case, the torsion coil spring 40 may be provided one for each of the shafts 22.

The guide surface 23A may have an arc shape when viewed from the direction of extension of the shaft 22. In this case, the guide surface 23A may have a curved shape projecting downward.

The article holding device 10 may exclude at least one of the guide surface 23A and the guided boss 32A. In this case, the movement of the arm 30 with respect to the housing 21 may be restricted by the movement of the shaft 22 with respect to the actuating portion 35A.

### Bearing 35

The article holding device 10 may exclude the shaft 22 from the holder 20 and include the bearing 35 in the holder 20, and may exclude the bearing 35 from the arm 30 and include the shaft 22 in the arm 30. For example, the support wall 21W of the holder 20 may include the actuating portion 35A, and the arm 30 may include the shaft 22 projecting from the side surface toward the support wall 21W.

The actuating portion 35A may have a curved shape extending downwardly outward. In this case, the actuating portion 35A have a curved shape projecting downward. The mounting portion 35B may have a linear shape extending in a tangential direction at the lower end of the actuating portion 35A.

The actuating portion 35A may have a linear shape extending parallel to the guide surface 23A. In this case, the movement of the shaft 22 accompanied by the translation of the shaft 22 with respect to the actuating portion 35A may be movement along the guide surface 23A involving only translation not including rotation.

The mounting portion 35B may have a curved shape, and the actuating portion 35A may have a linear shape extending in a tangential direction at an end of the mounting portion 35B.

The mounting portion 35B may be a bottomed groove that does not penetrate the locking wall 32. The actuating portion 35A may be a bottomed groove that does not penetrate the locking wall 32. The mounting portion 35B may be connected to an intermediate portion of the actuating portion 35A in the direction of extension of the actuating portion 35A. Furthermore, the bearing 35 may exclude the mounting portion 35B.

### Article Holding Device 10

The urging force that restrains the translation of the shaft 22 with respect to the actuating portion 35A may be applied by an urging member different from the torsion coil spring 40. For example, the article holding device 10 may include the coil spring 40 that urges the shaft 22 toward the lower end of the actuating portion 35A.

The first driven sloping surface 31T may have a linear shape extending inwardly downward when viewed from the direction of extension of the shaft 22.

1. An article holding device comprising:
a holder provided with a housing configured to receive an article from above the housing; and
an arm having an arm upper portion, wherein
the arm upper portion is configured to, when the article enters the housing, slidingly contact the article by receiving a downward external force from the article, and rotate about a shaft so as to exit the housing,
one of the holder and the arm is a first member provided with the shaft,
another of the holder and the arm is a second member provided with a bearing,
the bearing is provided with a slot in which the shaft is inserted, and the slot is formed so as to allow rotation of the shaft about the slot and translation of the shaft with respect to the slot by the external force,
the translation of the shaft with respect to the slot is restrained by an urging force, and
the arm upper portion is configured to exit the housing when the shaft moves in conjunction with the translation.

2. The article holding device according to claim 1, wherein
one of the holder and the arm is a guide member provided with a guide surface,
another of the holder and the arm is provided with a guided unit,
the guided unit is configured to be moved along the guide surface by the external force, and
the guide member is configured to interlock the movement of the shaft with respect to the slot with the movement of the guided unit along the guide surface.

3. The article holding device according to claim 2, wherein
the guide member is the holder, and
the guide surface extends from an outer peripheral surface of the housing downwardly outward of the housing.

4. The article holding device according to claim 3, wherein the guided unit is a projection extending from a side surface of the arm onto the guide surface.

5. The article holding device according to claim 1, further comprising an urging unit attached to the shaft and configured to urge the arm inward, wherein
the urging unit is configured to apply the urging force from the second member to the shaft.

6. The article holding device according to claim 1, wherein
the second member is provided with a mounting portion serving as a path to insert the shaft into the slot from outside the second member, and
the mounting portion extends in a direction different from a direction of extension of the slot.

7. The article holding device according to claim 6, wherein the mounting portion is provided with an opening to allow the shaft to pass through at an end opposite an end continuing to the slot.

8. An article holding device comprising:
a holder provided with a housing configured to receive an article from above the housing; and
an arm having an arm upper portion extending toward a lower inside of the housing, wherein
the arm upper portion is configured to, when the article enters the housing, slidingly contact the article by receiving a downward external force from the article, and rotate about a shaft so as to exit the housing,
one of the holder and the arm is provided with the shaft,
another of the holder and the arm is provided with a bearing,
the bearing is provided with a slot in which the shaft is inserted,
the slot extends downwardly outward of the housing, and the slot is formed so as to allow rotation of the shaft about the slot and translation of the shaft with respect to the slot by the external force,
the translation of the shaft with respect to the slot is restrained by an urging force, and
the arm upper portion is configured to exit the housing when the shaft moves in conjunction with the translation.
